(19) United States
(12) Patent Application Publication
(10) Pub. No.: US 2007/0003225 A1
(43) Pub. Date: Jan. 4, 2007

(54) Method and apparatus for recording information and playback information

(76) Inventors: Masataka Moteki, Ome-shi (JP); Seigo Ito, Hanno-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/455,737

(22) Filed: Jun. 20, 2006

(30) Foreign Application Priority Data
Jun. 20, 2005 (JP) 2005-179395

(51) Int. Cl. H04N 7/00

(52) U.S. Cl. 386/95

(57) ABSTRACT

To provide an information recording/playback apparatus according to an embodiment of the invention has a function of writing and reading in/from a recording medium with a data structure configured to include a main first management information group and a subsidiary second management information group, a function of checking whether management information described in a recording medium and divided into a smaller number of divisions is the first or second management information group, and holding the information, and a function of using the management information described in the management information group divided into a smaller number of divisions based on the held information, when reading information from a recording medium. Therefore, when a metadata partition is expanded in an optical disc provided with a metadata partition, a decrease in a seek speed is prevented.

### CROSS-REFERENCE TO RELATED APPLICATIONS

This is based upon and claims the benefit of priority from Japanese Patent Application No. 2005-179395, filed Jun. 20, 2005, the entire contents of which are incorporated herein by reference.

### BACKGROUND

1. Field

One embodiment of the invention relates to an information recording/playback apparatus and an information playback method, which can prevent a decrease in a seek speed when recording, erasing or playing back information in/from an optical disc recordable, erasable or playable information by using a laser beam.

2. Description of the Related Art

A DVD-standard optical disc has been put to practical use a long time ago. As a file system standard, DVD-Video (for play-only software) UDF (Universal Disc Format) 1.02 and DVD-VR (for a recordable disc) UDF 2.00 have been developed and used. UDF 2.50 has been developed for a next-generation optical disc (HD DVD, Blue-Ray) with increased recording density.

Comparing with the UDF 2.00, the UDF 2.50 adopts a structure called a metadata partition. This enables collective storage of management information such as FE (File Entry) and FID (File Identifier Descriptors) in a metadata partition. This is useful to increase the information seeking speed.

A metadata partition is expressed by a metadata file. A metadata partition can includes a metadata mirror file having the same contents as those of a metadata file, and can duplicate management information in addition to a metadata file.

A metadata partition can be expanded to accommodate an increase of a file entry (FE) and file identifier descriptor (FID) caused by an increase of a file and directory.

For example, Japanese Patent Application Publication (KOKAI) No. H10-312646 describes the dividing of a logical disc into several areas to reduce the time to move a magnetic head in a magnetic disc.

However, when expanding a metadata partition, there is the possibility of dividing a metadata file or metadata mirror file depending on the prerecorded data state on a recording medium. This may lower the seek speed. In this case, the advantage of metadata partition is not utilized, and the user's convenience is lost. For example, the data reading/writing time may be increased.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an information recording/playback apparatus according to the present invention;

FIG. 2 is an exemplary diagram showing an example of a data structure of a UDF 2.50;

FIG. 3 is an exemplary diagram showing an example of characteristic parts of the data structure of the UDF 2.50 shown in FIG. 2;

FIG. 4 is an exemplary diagram showing an example of a data structure when a metadata partition is expanded;

FIG. 5 is an exemplary flowchart showing a first means of reading data from a recording medium with the data structure shown in FIG. 3;

FIG. 6 is an exemplary flowchart showing a second means of reading data from a recording medium with the data structure shown in FIG. 3;

FIG. 7 is an exemplary diagram showing an example of a data structure in a recording medium immediately after changing a main metadata file;

FIG. 8 is an exemplary flowchart showing an example of a means of setting a metadata partition when initializing a recording medium; and

FIG. 9 is an exemplary diagram showing an example of a data structure in a recording medium immediately after setting a metadata partition according to the flowchart of FIG. 8.

### DETAILED DESCRIPTION

Various embodiments according to the invention will be described hereinafter with reference to the accompanying drawings. In general, according to one embodiment of the invention, an information recording/playback apparatus according to an embodiment of the invention has a function of writing and reading in/from a recording medium with a data structure configured to include a main first management information group and a subsidiary second management information group, a function of checking whether management information described in a recording medium and divided into a smaller number of divisions is the first or second management information group, and holding the information, and a function of using the management information described in the management information group divided into a smaller number of divisions based on the held information, when reading information from a recording medium.

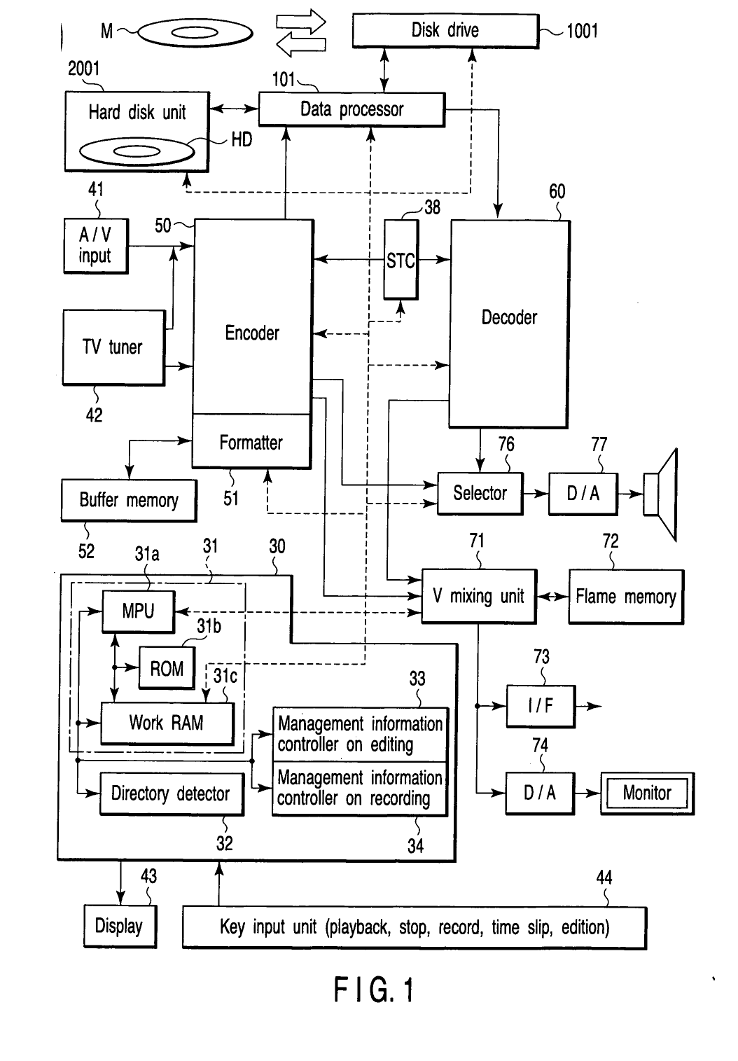

According to an embodiment, FIG. 1 shows an example of an optical disc apparatus or an information recording/playback apparatus according to an embodiment of the invention. The information recording/playback apparatus of FIG. 1 includes a personal computer (PC). The information recorded on a recording medium includes document information. The embodiment of the invention includes a digital video recorder, which will be explained hereinafter as an example of the embodiment.

FIG. 1 shows an example of an information recording/playback apparatus according to an embodiment of the invention. The information recording/playback apparatus of FIG. 1 uses a DVD-standard optical disc as a recording medium, and has a hard disc incorporated in a hard disc unit. The hard disc and DVD optical disc can be replaced by a semiconductor memory (memory card).

The information recording/playback apparatus (video recorder) 1 shown in FIG. 1 has a disc drive 1001 capable of creating a video file, in a DVD-standard medium (optical disc) M. The optical disc M may be a CD-standard disc, or HD (High Density) DVD and Blue-Ray disc with the recording capacity increased to higher than a current DVD optical disc.

The disc drive 1001 has a rotation control system which rotates an optical disc M at a predetermined speed, a laser drive system which emits a laser beam with a predetermined wavelength for playing back the information recorded in the optical disc M, and a laser optical system which guides the laser beam. These systems will not be described in detail.

The information recording/playback apparatus (video recorder) 1 can create a video file in a hard disc HD incorporated in a hard disc unit (hereinafter called a HDD) 2001.

Data (recording data) to be recorded on the optical disc loaded in the disc drive 1001 or in the hard disc HD of the HDD 2001 is recorded in a recording medium (previously specified, the optical disc M or hard disc HD) under the control of a data processor 101. By the control of the data processor 101, the recorded data is read (playback data is obtained) from the optical disc M of the disc drive 1001 or the hard disc HD of HDD 2001.

The data processor 101 handles recording or playback data as a predetermined unit, and includes a buffer circuit, a modulation/demodulation circuit, and an error correction unit.

The information recording/playback apparatus 1 has an encoder 50 that is a data processor for recording input information, a decoder 60 that is a data processor for playing back recorded data, and a microcomputer block 30 to control the operation of the information recording/playback apparatus 1, as main components.

The encoder 50 has an analog-digital converter for video and audio signals for digitizing input analog video and audio signals, a video encoder, and an audio encoder. The encoder 50 also includes a subsidiary video encoder.

The output of the encoder 50 is converted to a predetermined DVD-RAM format by a formatter 51 including a buffer memory, and supplied to the data processor 101.

The encoder 50 is supplied with external analog video and audio signals from an AV input unit 41, or analog video and audio signals from a TV tuner 42.

The encoder 50 can supply compressed digital video and audio signals directly to the formatter 51, when the compressed digital video and audio signals are directly input. The encoder 50 can also supply digital video and audio signals converted from analog signals, directly to a video mixing unit 71 and an audio selector 76.

The encoder 50 includes a not-shown video encoder. The video encoder converts a digital video signal to a digital video signal compressed at a variable bit rate based on the MPEG2 or MPEG1 standard. A digital audio signal is converted to a digital audio signal compressed at a variable bit rate based on the MPEG or AC-3 standard, or a linear PCM (non-compressed) digital audio signal.

As for a subsidiary video signal, when a subsidiary video signal is directly input from the AV (Audio Video) input unit 41 (e.g., a signal from a video player having an independent output terminal for a subsidiary video signal), or when a broadcasting signal of a DVD video signal having the equivalent data structure is received by the TV tuner 42, a subsidiary video signal included in the DVD video signal is encoded (run length coding) by the subsidiary video encoder, and a bit map of the subsidiary video (subsidiary video data) is created.

The encoded digital video signal, digital audio signal and subsidiary video data are packed as a video pack, an audio pack and a subsidiary video pack in the formatter 51. The packed video pack, audio pack and subsidiary video pack are further gathered (concentrated), and converted to a format (DVD Video format) defined by the DVD-Video standard or a format (DVD VR format) defined by the DVD-Recording standard.

The information (video, audio and auxiliary video data packs) formatted by the formatter 51 and management information (file system) created by a MPU (CPU) 31a (shown later) are supplied to the HDD 2001 or disc drive 1001 through the data processor 101, and recorded in the hard disc HD or optical disc M. The information recorded in the hard disc HD or optical disc M can be rewritten or duplicated to each other through the data processor 101. Namely, the data already recorded in the hard disc HD can be moved to the optical disc M, or duplicated. The data recorded in the optical disc M can be moved to the hard disc HD, or duplicated.

The format according to the invention defines the unit of handling data, and facilitates edition of the data. Therefore, the data recorded in the hard disc HD or optical disc M, video objects of programs for example, can be edited by deleting some or all or synthesizing (connecting) optional number of objects.

The microcomputer block 30 includes a main control unit 31 including a MPU (Micro Processing Unit) or CPU (Central Processing Unit) 31a, a ROM (Read Only Memory) 31b holding a control program for operating the MPU (CPU) 31a and various element and control blocks of the information recording/playback apparatus 1, and a RAM (Random Access Memory) 31c supplying a predetermined work area secured to execute a program. The RAM 31c may be built as firmware of MPU, for example.

The microcomputer block 30 performs detection of defective place and unrecorded area, setting of information recording position, recording of UDF and setting of AV address, according to the control program stored in the ROM 31b by the MPU (CPU) 31a taking the RAM 31c as a work area.

The microcomputer block 30 has a directory detector 32, a VMG information (whole video management information) creator (not described in detail), a copying information detector, a copying/scrambling information processor (RDI processor), a packet header processor, a sequence header processor, and an aspect ratio information processor. The microcomputer block 30 includes a recording management information controller 33 (hereinafter called a recording management controller) to execute recording of data when recording information (data), and an edition management information controller 34 (hereinafter called an edition management controller) to execute edition of recorded data. The means characterized by the invention is executed as a control program by the edition management information controller 34 and recording control information controller 33.

The result of execution by the MPU (CPU) 31a to be informed to the user is displayed as OSD (On Screen Display) in a display 43 of the information recording/playback apparatus 1, or a monitor (connected as an external unit, described later).

The microcomputer block 30 includes a key input unit 44 to input a control signal, or an operation signal from the user to operate the information recording/playback apparatus 1. The key input unit 44 corresponds to operation switches provided at optional positions of the information recording/playback apparatus 1, and a not-shown remote controller to input an operation signal through a not-shown remote receiver. The key input unit 44 may be a personal computer to input a control signal to the information recording/playback apparatus 1 by a wired or wireless means or by light (including infrared-rays). Namely, regardless of the form of the key input unit 44, when the user operates the key input unit 44, recording of input video and audio signals, playback of recorded contents, or edition of recorded contents are performed.

The microcomputer block 30 controls the disc drive 1001, HDD 2001, data processor 101, encoder 50 and decoder 60 at the timing determined based on the time data from the STC (System Time Clock) 38. Recording and playback are usually executed in synchronization with the time clock from the STC 38. Other operations may be executed at the timing independent of the STC 38.

The decoder 60 includes a separator to separate and take out a pack from a DVD format signal given a pack structure, a memory used for separating a pack and processing other signals, a V-decoder to decode a main video data (video pack contents) separated by the separator, a SP decoder to decode a subsidiary video data (subsidiary video pack contents) separated by the separator, and an A-decoder to decode an audio data (audio pack contents) separated by the separator. These components will not be described in detail.

The decoder 60 has a video processor, which synthesizes a decoded subsidiary video data with a decoded main video data at a predetermined timing, and superposes a menu, a highlight button, subtitles (display of text of audio data) and other subsidiary images.

An output video signal of the decoder 60 is input to a video mixing (V-mixing) unit 71. The V-mixing unit 71 synthesizes a text data (synthesized with a subsidiary video data) with a main video data. The V-mixing unit 71 is connected with a line to directly input signals from the TV tuner 42 and A/V input unit 41.

The V-mixing unit 71 is connected to a frame memory 72 used as a buffer, an I/F (Interface) 73 used to output an analog signal, and a D/A converter (Digital-Analog converter) 74 used to output a digital signal.

An audio signal (output) from the decoder 60 is input to a D/A converter (Digital-Analog converter) 77 through the selector 76 by the D/A converter 77, converted to an analog signal, and output to the outside. When a speaker is connected to the output end of the D/A converter 77 through a not-shown amplifier, for example, the user can listen to audio data (sound). The selector 76 is controlled by a select signal from the microcomputer block 30. Thus, the selector 76 can directly supply the D/A converter 77 with the digital signals from the TV tuner 42 and A/V input unit 41 (unnecessary to be processed by the encoder) passing through the encoder 50.

The formatter 51 of the encoder 50 creates various divided information during data recording, and periodically sends the information (information at the time of interruption to the beginning of GOP) to the MPU (CPU) 31a of the microcomputer block 30. The divided information includes the number of packs of VOBU, end address of I picture from the beginning of VOBU, and playback time of VOBU.

The formatter 51 supplies the MPU (CPU) 31a with the aspect ratio information from the aspect ratio information processor, at the start of recording. The MPU (CPU) 31a creates VOBU stream information (STI), based on this information. The STI includes resolution data and aspect data. Each decoder is initialized based on these data at the time of playback.

In the information recording/playback apparatus 1, one video file is prepared for one disc. A unit (size) of minimal continued information is determined to prevent interruption of playback image during accessing (seeking) data. This unit is called CDA (Contiguous Data Area). The CDA size is an integer multiple of ECC (Error Correction Code) block (16 sectors), and used as a recording unit in a file system.

The data processor 101 receives data of VOBU unit from the formatter 51 of the encoder 50, and supplies data of CDA unit to the disc drive 1001 or HDD 2001. The MPU (CPU) 31a of the microcomputer block 30 creates management information necessary for playing back recorded data, and sends the created management information to the data processor 101, when recognizing a data recording finish command indicating the end of recording data.

The management information is recorded in a recording medium (optical disc M or hard disc HD). Therefore, at the timing of encoding, the MPU (CPU) 31a can receive information of data unit (divided information) from the encoder 50. At the time of starting recording, the MPU (CPU) 31a recognizes the management information (file system) read from the optical disc M or hard disc HD, recognizes an unrecorded area of each disc, and sets a recorded area on data in a disc through the data processor 101.

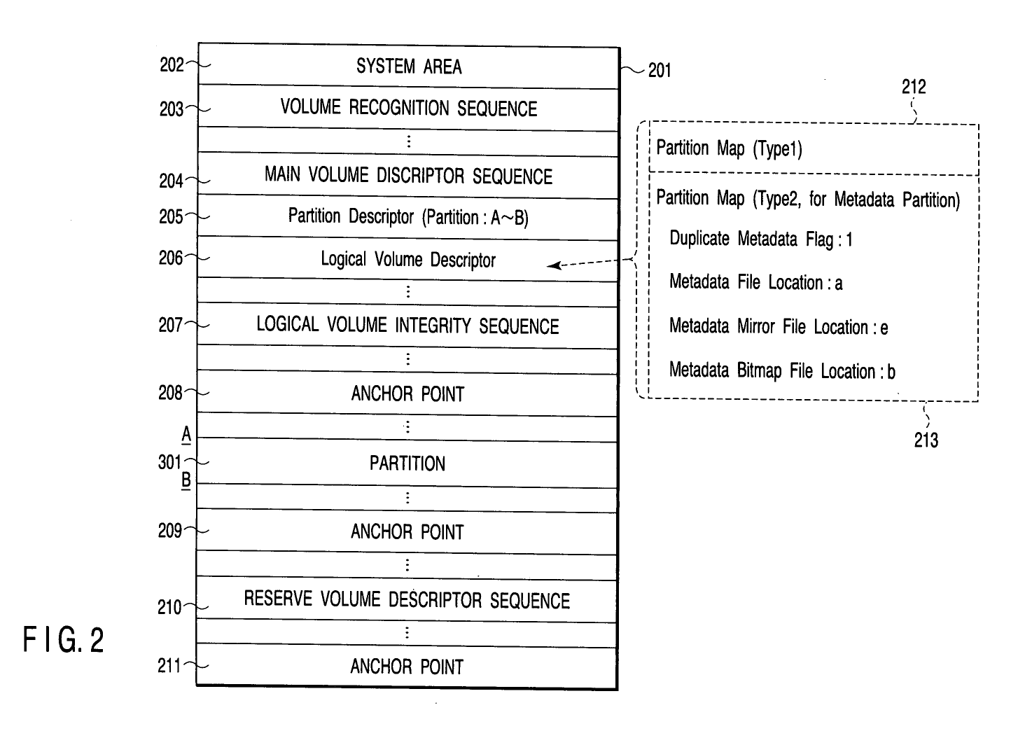

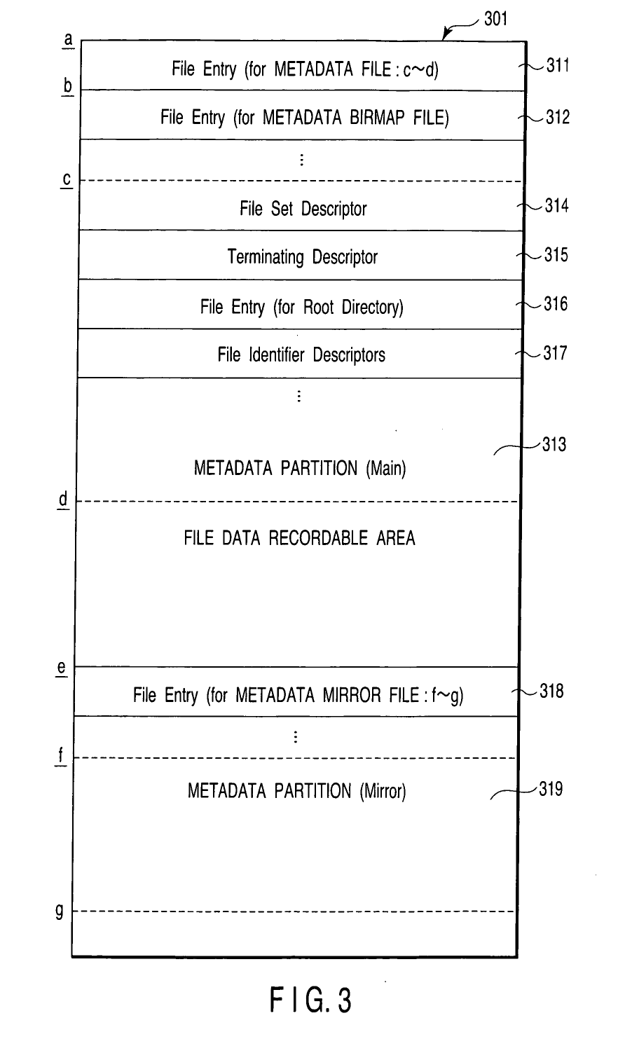

FIG. 2 and FIG. 3 schematically show the data structure defined in UDF (Universal Disc Format) Revision 2.50 (hereinafter called UDF 2.50).

FIG. 2 schematically shows the whole data structure on a recording medium. FIG. 3 schematically shows the inside of partition, which is a characteristic structure in the data structure shown in FIG. 2. In FIG. 2, [A] and [B] shown outside the frame indicate LSN (Logical Sector Number). In FIG. 3, a, b, c, . . . shown outside the frame indicate LBN (Logical Block Number) in the partition.

The configuration of the whole data structure 201 shown in FIG. 2 will be explained first.

In the whole data structure 201, a system area 202 is defined in the area other than UDF defined areas. Though not shown in FIG. 2, a system area 202 is an area with LSN values 0 to 16.

A volume recognition sequence (VRS) 203 is located next to the system area 202. Though omitted in FIG. 2, the VRS 203 includes a volume structure descriptor and a boot descriptor.

A volume descriptor sequence is defined next. The volume descriptor sequence includes a main volume descriptor sequence 204 and a subsidiary reserve volume descriptor sequence 210. These two volume descriptor sequences 204 and 210 have the same contents.

The positions of the volume descriptor sequence 204 and 210 are described in anchor volume descriptor pointers existing at anchor points 208, 209 and 211 described later.

The main volume descriptor sequence 204 will be explained as an example. The sequence 204 includes several kinds of descriptor. Explanation will be given on a partition descriptor 205 and logical volume descriptor 206.

The partition descriptor 205 is used to describe a directory, file management information, and the size and position of partition 301 that is an area to write file data. In this example, the partition 301 is defined by a LSN value in the area of A to B.

The logical volume descriptor 206 is used to describe information about a logical volume. The logical volume descriptor 206 has a data field called Partition Maps to describe information called a partition map.

In a partition map, “Type 1” 212 and “Type 2”213 are defined. The “Type 1” partition map is defined by the ECMA 167 standard that is the base of the UDF standard. The “Type 1” partition map indicates a directory, file management information, and a normal partition to write file data. The “Type 2” partition map indicates partitions defined by other than the ECMA 167 standard. The “Type 2” partition map is used to indicate a UDF-specific partition map.

As a partition map specific to the UDF 2.50, there is a metadata partition. Namely, FIG. 2 shows the “Type 2” partition map indicating a metadata partition.

The “Type 2” partition map includes information indicating the file entry (FE) positions of metadata file, metadata mirror file, metadata bitmap file, and information such as a duplicate metadata flag indicating the existence of a metadata mirror file.

Though not shown in FIG. 2, in the UDF 2.50 standard, the “Type 2” partition map indicating a metadata partition, that is, a metadata partition map includes identifier information called “*UDF Metadata Partition” in the identifier field.

In the UDF standard, a logical volume contents use field of the logical volume descriptor 206 is used to describe the position information of a file set descriptor, which is the basis for accessing a directory and file.

Though omitted in FIG. 2, the volume descriptor sequence includes other several kinds of descriptors such as a primary volume descriptor.

Next to the volume descriptor sequence (204), a logical volume integrity sequence 207 is defined. Though omitted in FIG. 2, the logical volume integrity sequence 207 includes a logical volume integrity descriptor.

The anchor points 208, 209 and 211 include anchor volume descriptor pointers describing the position information of the main volume descriptor sequence 204 and reserve volume descriptor sequence 210, as explained before.

The anchor volume descriptor pointer is an entry to access the data of a recording medium, and the describing position is defined by the UDF standard.

In the UDF 2.50, an anchor point must exist in at least two of the following three positions
“LSN=256”,
“LSN=N-256”,
“LSN=N”
N is the last LSN.

In FIG. 2, the anchor point 208 exists at the position of “LSN=256”, the anchor point 209 exists at the position of “LSN=N-256”, and the anchor point 211 exists at the position of “LSN=N”.

Next, the inside of a partition map will be briefly explained with reference to FIG. 3.

A file entry (FE) exists at the position of LBN=a, b, e described in the metadata partition map 213 explained before.

In FIG. 3, a file entry 311 existing at the position of LBN=a, indicates a file, in which the LBN value areas over c to d. The file that the LBN value areas over c and d is a metadata file 313, and its inside space is called a metadata partition. This space collectively describes management information, such as a directory, a file entry for a file and a file identifier descriptor (FID).

This structure called a metadata partition is newly adopted on and after the UDF 2.50. In the conventional UDF revision, if deletion or addition of a file and directory are repeated, the management information such as FE and FID is recorded in a space area of a recording medium at that point of time, and these management information exist at scattered positions on the recording medium.

If the management information such as FE and FID are scattered on a recent blue-Ray disc using a blue laser beam and large-capacity HD DVD, the seek time becomes long. The metadata partition is adopted in the UDF 2.50 to decrease the seek time by storing the FE and FID collectively on a recording medium.

In FIG. 3, the FE 318 existing at the position of LBN=e indicates a file in which the LBN value areas over f to g. The file in which the LBN value areas over f to g is a metadata file [Mirror] 319.

The metadata mirror file 319 has the same contents as the metadata file 313. This is adopted in the UDF 2.50 to increase the robustness against damages of a recording medium, such as stains and damages of a disc, not included in the conventional UDF revision. Use of a metadata mirror file is optional. Use of a metadata mirror file is desirable to increase the robustness. Many systems based on the UDF 2.50 will use a metadata mirror file, but not compulsive.

Whether a metadata mirror file is used is judged by a duplicate metadata flag existing in the metadata partition map 213 described before.

When the duplicate metadata flag is set to “1”, a metadata mirror file (319) is used in addition to a main metadata file (313). When, the duplicate metadata flag is cleared (set to “0”), since a metadata mirror file does not exist.

In FIG. 3, FE 312 existing at the position of LBN=b indicates a metadata bitmap file indicating whether logical blocks in a metadata partition are used for data recording. A metadata bitmap file can exist as an independent file, or can be included in an allocation descriptors field of FE depending on standards. The example of FIG. 3 is the latter. A metadata bitmap file is included in the allocation descriptors field of FE 312, and not shown. A metadata bitmap file indicates the state of using logical blocks in a metadata partition, and is not for the whole partition 301 including a metadata partition. There is another space bitmap descriptor indicating the state of using logical block in the partition 301, but omitted in FIG. 3.

Next, a metadata file and metadata mirror file will be explained in detail. The contents of the metadata partitions of the metadata file 313 and metadata mirror file 319 are the same, and the contents of the metadata partition of the metadata file will be explained.

A metadata partition is used to describe directory information such as root directory and sub-directory, and file management information such as FE and FID. FIG. 3 shows the image immediately after initialization of a recording medium. At this point of time, only a root directory is constructed. As a sub-directory is constructed and a file is recorded, FE and FID are sequentially described in the metadata partition.

The FE and FID as file management information are described in the metadata partition, but file data is written out of the metadata partition.

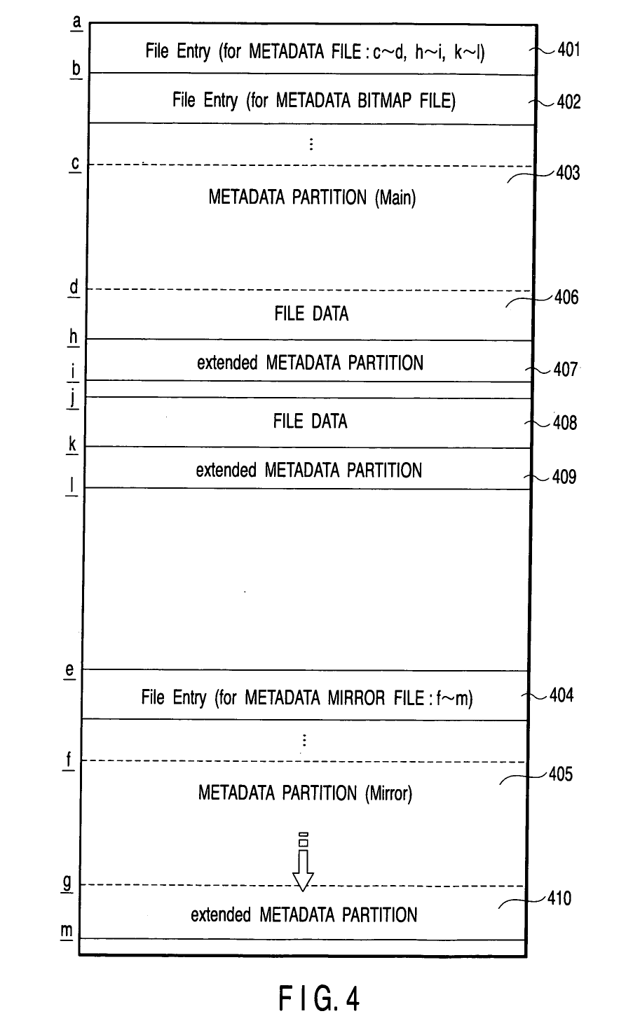

FIG. 4 shows an example of expanding a data structure by a conventional method, when a metadata partition is expanded. FIG. 4 shows only the state of the inside of the partition 301 already explained in FIG. 3. The metadata partition contents are omitted to simplify explanation.

As a new sub-directory is constructed or a new file is added on a recording medium, FE and FID as management information are added to the inside of a metadata partition.

In such a case, the area of a metadata partition can be expanded to accept additional files.

The area of a metadata partition is described in the allocation descriptors field of the FE indicating a metadata file or metadata mirror file, and the area of a metadata partition can be expanded by re-setting the description of the field.

However, depending on the data recording state on a recording medium at the time of the expansion of a metadata partition, a metadata file and metadata mirror file as substance of a metadata partition are not gathered, but may be divided furthermore.

In the example of FIG. 4, the area 410 of the expanded metadata partition and a certain area can be secured for the metadata mirror file 405, and the continuous area of LBN=f to m is described in FE 404 of the metadata mirror file, as a new metadata partition after the expansion.

Contrarily, for the main metadata partition 403 (in FIG. 4), the file data 406 is recorded in the area of LBN=d to h, and a file data 408 has been recorded in the area of LBN=j to k. Thus, a contiguous group of metadata file cannot be built, and the partition is further divided into LBN=c to d, LBN=h to i and LBN=k to l, that is, three metadata files (the metadata file is divided into three).

In such a case, when accessing the metadata partition expressed by the main metadata file, it is necessary to access the divided areas of the metadata file (by several times), and the seek speed is decreased. This does not utilize the advantage of a metadata partition characteristic of the UDF 2.50, and the user's convenience is decreased, for example, the speed of accessing an optional file is decreased.

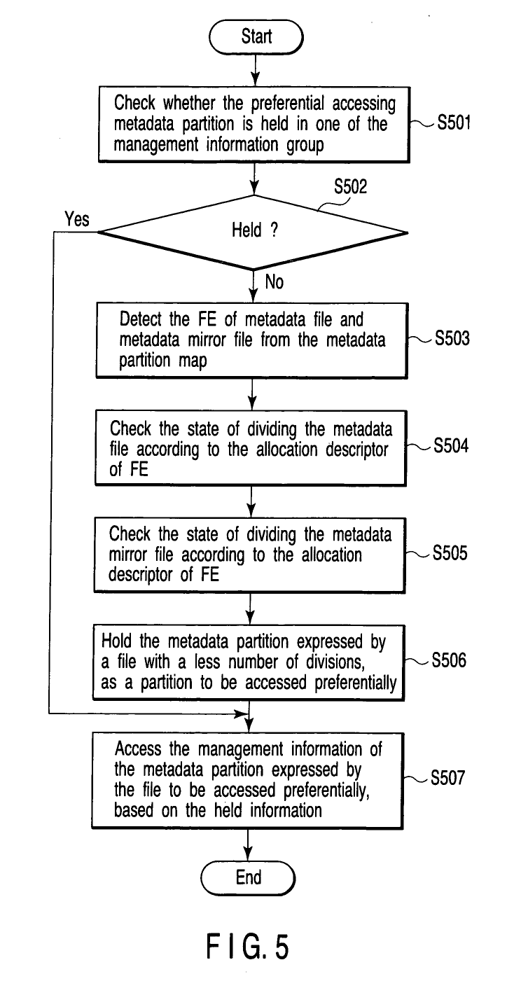

An embodiment of the invention will now be explained with reference to FIG. 5.

FIG. 5 is a flowchart showing a first means embodying the invention. The flowchart of FIG. 5 shows a method of preferentially accessing a metadata partition divided into less number of divisions, regardless of the file is a data file or metadata mirror file.

First, in step S501, check whether the information recording/playback apparatus 1 holds the information to determine the priority in accessing a metadata file and metadata mirror file.

Next, if it is judged that the information recording/playback apparatus does not hold the information to determine the accessing priority is in step S502 (S502-No), the description positions of FE of metadata file and metadata mirror file are detected in step S503 according to the description contents of a metadata partition map. Namely, in step S502, the existence of the information to determine the accessing priority is checked. The operation of a subsequent step is branched according to whether the information exists or not.

In step S504, the state of dividing a metadata file is checked according to the contents of the allocation descriptors field of FE.

In step S505, the state of dividing a metadata mirror file (whether divided, and the number of divisions if divided) is checked according to the contents of the allocation descriptors field of FE.

In step S506, a metadata file or a metadata mirror file divided into less number of divisions and given the accessing priority is selected according to the results of steps S504 and S505, and the priority information is held in the information recording/playback apparatus 1.

In step 507, a metadata partition to be preferentially accessed is selected based on the information about which file, a metadata file or a metadata mirror file, is to be preferentially accessed, held in the information recording/playback apparatus 1, and the directory information and file management information described in the selected metadata partition are read, and a series of operations is finished.

If it is confirmed that the apparatus holds the information about the accessing priority of a metadata file and metadata mirror file in step S502, the step S507 is executed.

A decrease in the seek speed when reading data can be prevented by preferentially accessing a metadata file or metadata mirror file divided into less number of divisions and given the accessing priority, according to the description of a metadata partition, as described above. Therefore, the user's convenience is not decreased, for example, the speed of accessing a desired file is not decreased.

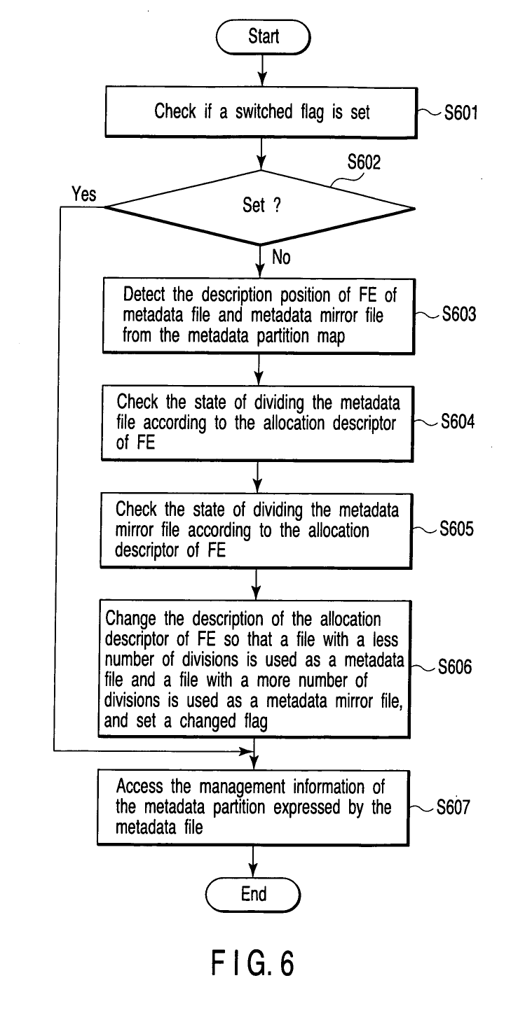

FIG. 6 is a flowchart showing the outline of a second means of reading information from a recording medium. The flowchart of FIG. 6 shows an example of preferentially accessing a metadata file or metadata mirror file divided into less number of divisions and switched as a main metadata file.

In step S601, whether a flag indicating the end of the processing to switch a metadata partition map divided into less number of divisions as a main metadata file is set in the recording/playback apparatus 1 is checked (whether the flag indicating the existence of the switching operation is set to “1”).

In step S602, the operation is branched according to whether the flag is set or not. When the flag is not set, go to step S603. If the flag is set, go to step S607 by skipping the steps S603 to S606.

In step S603, the description contents of a metadata partition map are interpreted and the description positions of the FE of the metadata file and metadata mirror file are detected.

In step S604, the state of dividing a metadata file is checked for a main metadata file according to the description contents of the allocation descriptors field of FE.

In step S605, the state of dividing a metadata mirror file is checked according to the description contents of the allocation descriptors field of FE.

In step S606, a metadata partition of a metadata file or metadata mirror file divided into less number of divisions is switched to a main metadata file and the other file (the remaining metadata file) is switched to a metadata mirror file. Concretely, the positions of FE of metadata file and metadata mirror file described in the metadata partition map are rewritten and the file divided in less number of divisions is switched to a main metadata file. A flag indicating the end of this switching operation is set in the recording/playback apparatus 1.

Finally, in step S607, the metadata partition expressed by the main metadata file is preferentially accessed, and the directory information and file management information described in the partition are read, and a series of operations is finished.

As described above, the metadata file switched (previously) as a file expressing a metadata partition divided into less number of divisions is preferentially accessed. Namely, a decrease in the seek speed when reading data can be prevented by defining a metadata file or metadata mirror file divided into less number of divisions as a main metadata file to be accessed. Therefore, the user's convenience is not decreased, for example, the speed of accessing a desired file is not decreased.

By following the flowchart shown in FIG. 6, a decreased seek speed can also be prevented when playing back (information recorded on a recording medium) by using other recording/playback apparatus given a simple logic to substantially fix a main metadata file.

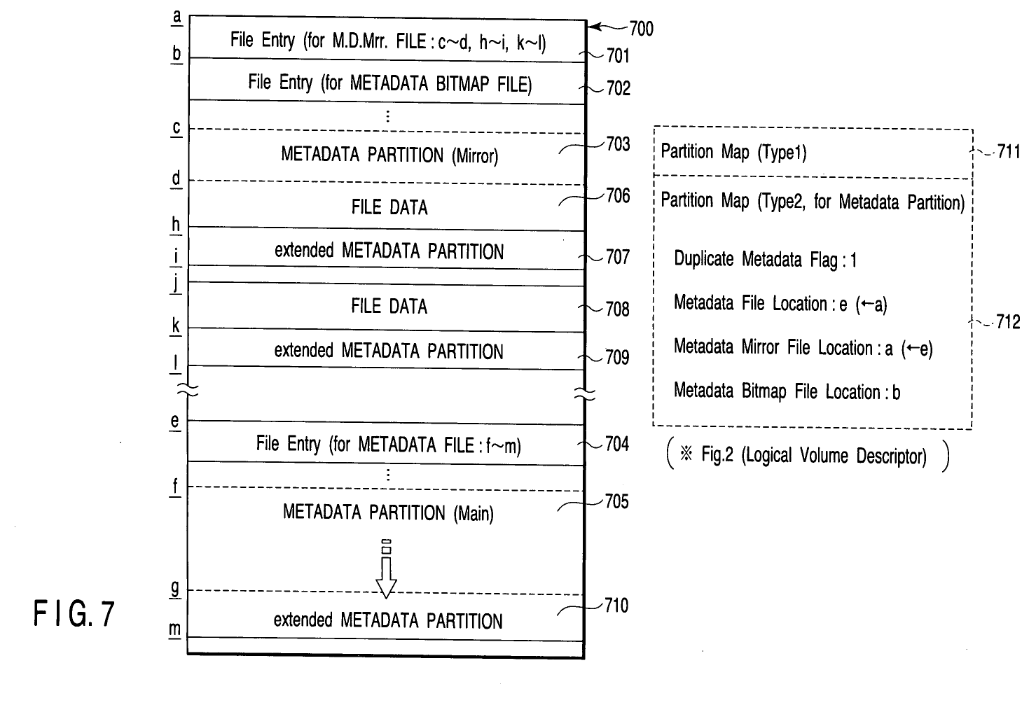

FIG. 7 shows the data structure on a recording medium immediately after switching a metadata partition with a less number of divisions as a main metadata file according to the flowchart explained in FIG. 6. FIG. 7 shows the state of switching a metadata file for a recording medium in the state as explained in FIG. 4. FIG. 7 shows the state of only the inside of the partition (301) shown in FIG. 3. To simplify description and discriminate from FIG. 4, the 100^{th} digit reference numerals are replaced by 700^{th}, and description of the same data structure with the 100^{th} and 1^{st} digit numerals is omitted.

As seen from FIG. 7, comparing with the data structure explained in FIG. 4, the description contents of a Type 2 metadata partition 712 are changed in the data structure shown in FIG. 7. (The Type 1 partition map 711 is not changed.) Namely, in the data structure shown in FIG. 7, the position of FE of a metadata file is changed to LBN=e and the position of FE of a metadata mirror file is changed to LBN=a. Therefore, It is seen that the metadata partition positioned collectively at LBN=f to m is changed to a main metadata file and the metadata partition divided into three is changed to a metadata mirror file.

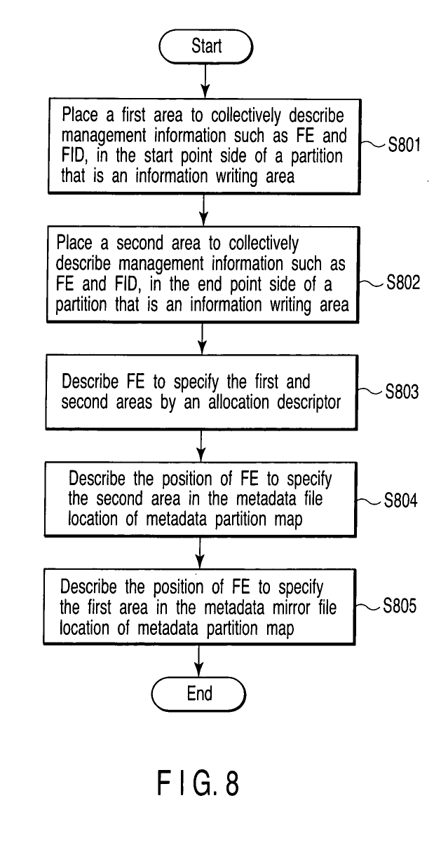

FIG. 8 is a flowchart showing the outline of a means of setting a metadata partition when initializing a recording medium.

In step S801, a first area to concentrate file management information FE and FID is set in a partition as an information writing area.

When a recording medium is an optical disc M such as DVD, data is recorded from inner tracks of the disc toward outer tracks. Therefore, if a specific structure is not given, an innermost track of a disc is a start point of partition and an outermost track is an end point of partition.

In the flowchart shown in FIG. 8, the first area is set at the start point of partition in step S801.

Next, in step S802, a second area to concentrate the FE and FID is set in a partition as an information writing area. The second area is set at the end point of partition (close to an outer periphery when a recording medium is an optical disc).

In step S803, the FE indicating the first and second areas are described in the allocation descriptors field is described in a recording medium.

In step S804, the positions of FE indicating the second area is described in the metadata file location field of a metadata partition map.

Finally, in step S805, the position of FE indicating the first area is described in the metadata mirror file location field of a metadata partition map, and a series of operations is finished.

As described above, a metadata mirror file is set in the start point side of a recording medium and a main metadata file is set in the end point side. Therefore, when a recording medium is an optical disc such as DVD, the number of dividing the main metadata file is decreased when the metadata partition is expanded, even if the recording (file) data is increased from the inner tracks of a disc toward the outer tracks.

Namely, in the inner tracks of a disk or in the start point side of a recording medium, a risk of dividing a metadata file (increasing the number of divisions) is easily estimated, but the risk of dividing a metadata file can be decreased by setting a main metadata file in the end point side of a recording medium.

Therefore, a decrease in the seek speed is prevented, and the user's convenience is not decreased, for example, the access time is not increased.

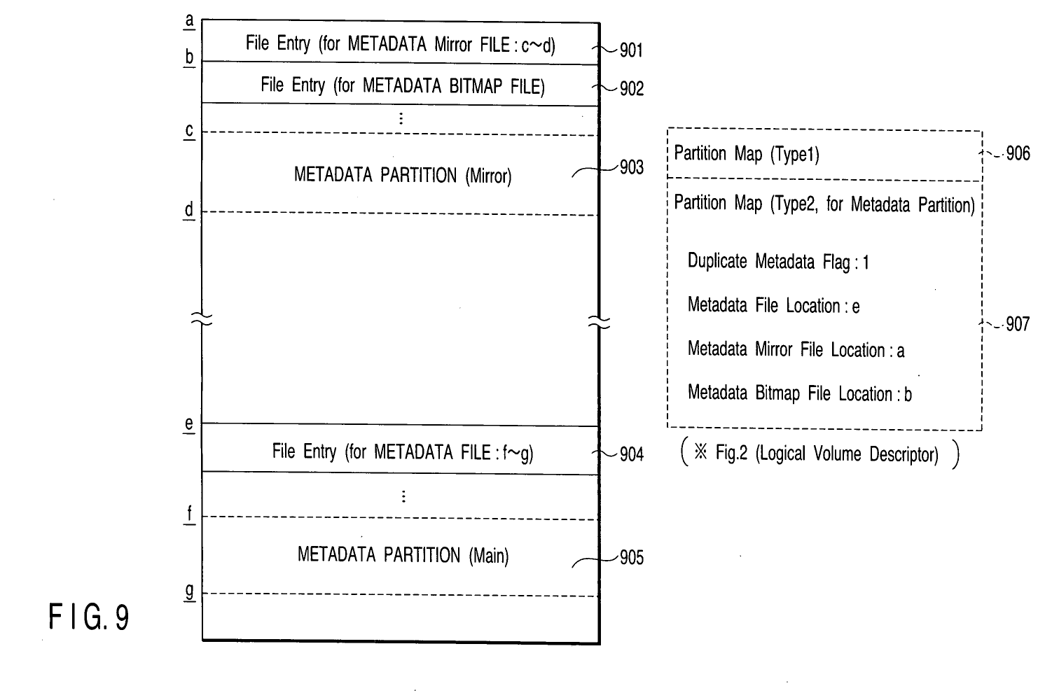

FIG. 9 shows a data structure in a recording medium immediately after setting a metadata partition according to the flowchart of FIG. 8. FIG. 9 shows the state of only the inside of the partition (301) explained in FIG. 3. To simplify description and discriminate from FIG. 4 (and FIG. 6), the 100^{th} digit reference numerals are replaced by 900^{th}, and description of the same data structure with the 10^{th} and 1^{st} digit numerals is omitted.

In FIG. 9, the “a” side of “a” to “g” given out of the frame indicates the start point side of a recording medium, and the “g” side indicates the end point side. File data is recorded from “a” to “g”.

As seen from FIG. 9, comparing with the data structure explained in FIG. 4, a metadata mirror file (903) is set in the start point side of a recording medium and a main metadata file (905) is set in the end point side in the data structure shown in FIG. 9.

As the description contents of a Type 2 metadata partition 907, a metadata file location is described as “e” (end side) in a logical block number LBN.

By using this data structure, when recording (file) data is increased and a metadata partition is expanded as explained above, a main metadata file set in the end point side of a recording medium has the increased possibility of ensuring an area continued from an area of an original metadata file as an expanded area. Namely, undesired dividing of a metadata partition of at least one of metadata file and metadata mirror file is decreased.

As described hereinbefore, according to an embodiment of the invention, a decrease in the seek speed can be prevented by accessing preferentially a metadata partition with a less number of divisions and reading information, or by describing (placing) a metadata partition to be mainly accessed at a position with less risk of dividing (the outer periphery (end) side of an optical disc). This increase the user's convenience, for example, a speed of accessing an optical file is not decreased.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The embodiments may be embodied in other specific forms without departing from its spirit or essential characteristics. A digital video recorder is taken as an example of the invention. Other apparatus, for example, a personal computer (PC) may be available as an information recording/playback according to the invention. Further, embodiments may be embodied in a moving image camera using an optical disc as a recording medium and portable acoustic apparatus containing music data.

What is claimed is:

1. An information recording/playback apparatus having a function of writing and reading in/from a recording medium with a data structure configured to include a main first management information group and a subsidiary second management information group, comprising:
checking whether a management information group described in a recording medium and divided into a smaller number of divisions is the first or second management information group, and holding the information; and
using the management information described in the management information group divided into a smaller number of divisions based on the held information, when reading information from a recording medium.

2. An information recording/playback apparatus having a function of writing and reading in/from a recording medium with a data structure configured to include a main first management information group and a subsidiary second management information group, comprising:
checking whether a management information group described in a recording medium and divided into a smaller number of divisions is the first or second management information group, and holding the information;
setting the management information group divided into a smaller number of divisions in the main first management information group, based on the held information; and
setting the management information group divided into a larger number of divisions in the subsidiary second management information group, and using the management information described in the set first management information group, when reading information from a recording medium.

3. An information recording/playback apparatus having a function of writing and reading in/from a recording medium with a data structure configured to include a main first management information group and a subsidiary second management information group, comprising writing the second management information group in the side close to a start point of an information writing area on a recording medium, and the first management information group in the side close to an end point of the information writing area, when writing information in a recording medium.

4. An information playback method comprising:
detecting that there are two or more areas to write management information in a recording medium configured to hold file data;
determining an area to be accessed first by referring to areas to write management information, when there are two or more areas to write management information; and
reading information recorded in a recording medium based on management information written in the area to be accessed first.

5. The information playback method according to claim 4, further comprising checking whether any one of areas is specified to be accessed preferentially, before determining the area to be accessed first, when the existence of two or more areas to write management information is detected.

6. The information playback method according to claim 4, further comprising specifying an area divided into a smaller number of divisions as an area to be accessed first, and writing information to permit a preferential access to the specified area, when there are two or more areas to write management information.

7. An information recording method having a function of writing a recording medium with a data structure configured to include a first management information group and a second management information group, comprising:
writing one of the first and second management information groups in an optional recording area in a recording medium;
writing the other management information group in an area configured to ensure an independent recording area in a recording medium, even if file data is sequentially recorded; and
writing information to permit a preferential access to the management information group written in the area configured to ensure an independent recording area, even if file data is sequentially recorded.

8. The information recording method according to claim 7, wherein even if file data is sequentially recorded, the area configured to ensure an independent recording area is defined in the end side of an information recording area of a recording medium, particularly in the outer track side when a recording medium is like a disc.

9. An information recording/playback apparatus which records file data in a recording medium according to a predetermined data structure, and plays back information from a recording medium according to a request, comprising:
a means for controlling writing of management information data, which writes a first management information group including at least one management information to manage file data, and a second management information group including at least one management information duplicated from the management information held by the first management information group, independently in a specified recording area of a recording medium different from an area configured to record file data of a recording medium; and
a means for judging the priority of management information, which specifies accessing to a playback file data based on the management information recorded in a management information group divided into a smaller number of divisions out of first and second management information groups written in a recording medium, when playing back file data.
